(19) United States
(12) Patent Application Publication
(10) Pub. No.: US 2011/0025687 A1
(43) Pub. Date: Feb. 3, 2011

(54) IMAGE PROCESSING DEVICE, IMAGE PROCESSING DEVICE CONTROL METHOD, PROGRAM, AND INFORMATION STORAGE MEDIUM

(75) Inventor: Keiichiro Arahari, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KONAMI DIGETAL ENTERTAINMENT CO., LTD., Tokyo (JP)

(21) Appl. No.: 12/934,905

(22) PCT Filed: Mar. 18, 2009
(86) PCT No.: PCT/JP2009/055270

§ 371 Date: Sep. 27, 2010

(30) Foreign Application Priority Data
Mar. 28, 2008 (JP) 2008-087909

(51) Int. Cl. G06T 15/00

(52) U.S. Cl. 345/419

(57) ABSTRACT

To provide an image processing device capable of alleviating processing loads in a case of expressing a state in which a part of a foot (shoe) of a player is hidden by turf growing on a field, for example. The present invention relates to the image processing device for displaying on a screen a virtual three-dimensional space in which a first object and a second object (52) are located, the second object moving so as to cause a distance from the first object to change. In the present invention, a third object (54) for performing display-output related to the first object is located in the virtual three-dimensional space, and the third object (54) moves according to movement of the second object (52). Then, the display-output of the third object (54) on the screen is restricted based on a distance between the first object, and the second object (52) or the third object (54).

### TECHNICAL FIELD

The present invention relates to an image processing device, an image processing device control method, a program, and an information storage medium.

### BACKGROUND ART

There is known an image processing device which displays a virtual three-dimensional space on a screen. For example, on a game device (image processing device) for executing a soccer game, the virtual three-dimensional space in which a field object representing a field, player objects representing soccer players, and a ball object representing a soccer ball are located is displayed on a game screen.

[Patent Document 1] JP 2006-110218 A

### DISCLOSURE OF THE INVENTION

### Problems to be Solved by the Invention

For example, on such a game device for executing a soccer game as described above, there is a case where an expression of a state in which a part of a foot (boot) of a player is hidden by turf growing on a field is desired. Up to now, as a method for creating such an expression, a method of setting a large number of turf objects representing the turf over an entirety of a field object has been used. However, in a case where this method is used, a large number of turf objects must be located over the entirety of the field object, which increases processing load.

The present invention has been made in view of the above-mentioned problem, and an object thereof is to provide an image processing device, an image processing device control method, a program, and an information storage medium capable of alleviating processing loads in a case of, for example, expressing a state in which a part of a foot (boot) of a player is hidden by turf growing on a field.

### Means for Solving the Problems

In order to solve the above-mentioned problem, an image processing device according to the present invention is an image processing device for displaying on a screen a virtual three-dimensional space in which a first object and a second object are located. The image processing device includes: means for locating a third object for performing display-output related to the first object in the virtual three-dimensional space, and causing the third object to move according to movement of the second object; and restricting means for restricting the display-output of the third object on the screen based on a distance between the first object, and the second object or the third object.

Further, an image processing device according to the present invention is an image processing device for displaying on a screen a virtual three-dimensional space in which a first object and a second object are located. The image processing device includes: means for locating a third object for performing display-output related to the first object in the virtual three-dimensional space, and causing the third object to move according to movement of the second object; and restricting means for restricting the display-output of the third object on the screen according to a change of a distance between the first object, and the second object or the third object.

Further, a control method for an image processing device according to the present invention is a control method for an image processing device for displaying on a screen a virtual three-dimensional space in which a first object and a second object are located. The control method for an image processing device includes: a step of locating a third object for performing display-output related to the first object in the virtual three-dimensional space, and causing the third object to move according to movement of the second object; and a restricting step of restricting the display-output of the third object on the screen based on a distance between the first object, and the second object or the third object.

Further, a control method for an image processing device according to the present invention is a control method for an image processing device for displaying on a screen a virtual three-dimensional space in which a first object and a second object are located. The control method for an image processing device includes: a step of locating a third object for performing display-output related to the first object in the virtual three-dimensional space, and causing the third object to move according to movement of the second object; and a restricting step of restricting the display-output of the entirety or a part of the third object on the screen according to a change of a distance between the first object, and the second object or the third object.

Further, a program according to the present invention is a program for causing a computer to function as an image processing device for displaying on a screen a virtual three-dimensional space in which a first object and a second object are located. The program further causes the computer to function as: means for locating a third object for performing display-output related to the first object in the virtual three-dimensional space, and causing the third object to move according to movement of the second object; and restricting means for restricting the display-output of the third object on the screen based on a distance between the first object, and the second object or the third object.

Further, a program according to the present invention is a program for causing a computer to function as an image processing device for displaying on a screen a virtual three-dimensional space in which a first object and a second object are located. The program further causes the computer to function as: means for locating a third object for performing display-output related to the first object in the virtual three-dimensional space, and causing the third object to move according to movement of the second object; and restricting means for restricting the display-output of the entirety or a part of the third object on the screen according to a change of a distance between the first object, and the second object or the third object.

Further, an information storage medium according to the present invention is a computer-readable information storage medium having the above-mentioned program recorded thereon. Further, a program delivery device according to the present invention is a program delivery device including an information storage medium having the above-mentioned program recorded thereon, for reading the above-mentioned program from the information storage medium and delivering the program. Further, a program delivery method according to the present invention is a program delivery method of reading the above-mentioned program from the information storage medium having the above-mentioned program recorded thereon and delivering the program.

The present invention relates to the image processing device for displaying on the screen the virtual three-dimensional space in which the first object and the second object are located. In the present invention, the third object for performing the display-output related to the first object is located in the virtual three-dimensional space, and the third object moves according to the movement of the second object. Further, based on the distance between the first object and the second object, or a distance between the first object and the third object (or according to the change of the distance between the first object and the second object, or the distance between the first object and the third object), the display-output of the third object on the screen is restricted. The phrase “the display-output of the third object on the screen is restricted” includes, for example, inhibiting the entirety or a part of the third object from being displayed on the screen and making it difficult for a user to recognize (see) the third object. According to the present invention, it becomes possible to express a state in which a part of a foot (shoe) of a player is hidden by turf growing on a field by, for example, setting an object representing the field as “first object”, setting an object representing the foot (shoe) of a soccer player as “second object”, and setting an object representing the turf as “third object”. In addition, according to the present invention, it becomes possible to alleviate processing load in a case of performing such an expression as described above.

Further, according to one aspect of the present invention, the second object may be a three-dimensional object, and the restricting means may restrict the display-output of the third object on the screen by including the entirety or a part of the third object in the second object.

Further, according to another aspect of the present invention, the restricting means may restrict the display-output of the third object on the screen by reducing a size of the third object.

Further, according to a further aspect of the present invention, the image processing device may include means for storing third object control data obtained by associating a condition regarding the distance between the first object, and the second object or the third object, with position controlling information regarding position control of a vertex of the third object, and the restricting means may control the position of the vertex of the third object based on the position controlling information corresponding to the condition satisfied by a current distance between the first object, and the second object or the third object.

Further, according to a still further aspect of the present invention, the image processing device may include means for storing third object control data for specifying a position of a vertex of the third object in each frame in a case where the second object moves, and the restricting means may control the position of the vertex of the third object based on the third object control data.

Further, according to a yet further aspect of the present invention, the restricting means may restrict the display-output of the third object on the screen by increasing a transparency of the entirety or a part of the third object.

Further, according to a yet further aspect of the present invention, the image processing device may include means for storing third object control data obtained by associating a condition regarding the distance between the first object, and the second object or the third object, with transparency controlling information regarding transparency control of each point of the third object, and the restricting means may control the transparency of each point of the third object based on the transparency controlling information corresponding to the condition satisfied by a current distance between the first object, and the second object or the third object.

Further, according to a yet further aspect of the present invention, the image processing device may include means for storing third object control data for specifying the transparency of each point of the third object in each frame in a case where the second object moves, and the restricting means may control the transparency of each point of the third object based on the third object control data.

Further, according to a yet further aspect of the present invention, the restricting means may restrict the display-output of the third object on the screen in a case where the distance between the first object, and the second object or the third object, is equal to or larger than a predetermined distance.

Further, according to this aspect, the restricting means may include means for restricting the display-output of a part of the third object on the screen based on a posture of the second object in a case where the distance between the first object, and the second object or the third object, is smaller than the predetermined distance.

Further, an image processing device according to the present invention is an image processing device for displaying on a screen a virtual three-dimensional space in which a first object and a second object are located. The image processing device includes means for locating a third object for performing display-output related to the first object in the virtual three-dimensional space, and causing the third object to move according to movement of the second object, and restricting means for restricting the display-output of the third object on the screen based on a posture of the second object or the third object.

Further, a control method for an image processing device according to the present invention is an control method for an image processing device for displaying on a screen a virtual three-dimensional space in which a first object and a second object are located. The control method for an image processing device includes a step of locating a third object for performing display-output related to the first object in the virtual three-dimensional space, and causing the third object to move according to movement of the second object, and a step of restricting the display-output of the third object on the screen based on a posture of the second object or the third object.

Further, a program according to the present invention is a program for causing a computer to function as an image processing device for displaying on a screen a virtual three-dimensional space in which a first object and a second object are located. The program further causes the computer to function as means for locating a third object for performing display-output related to the first object in the virtual three-dimensional space, and causing the third object to move according to movement of the second object, and restricting means for restricting the display-output of the third object on the screen based on a posture of the second object or the third object.

Further, an information storage medium according to the present invention is a computer-readable information storage medium having the above-mentioned program recorded thereon. Further, a program delivery device according to the present invention is a program delivery device including an information storage medium having the above-mentioned program recorded thereon, for reading the above-mentioned program from the information storage medium and delivering the program. Further, a program delivery method according to the present invention is a program delivery method of reading the above-mentioned program from the information storage medium having the above-mentioned program recorded thereon and delivering the program.

The present invention relates to the image processing device for displaying on the screen the virtual three-dimensional space in which the first object and the second object are located. In the present invention, the third object for performing the display-output related to the first object is located in the virtual three-dimensional space, and the third object moves according to the movement of the second object. Further, based on the posture of the second object or the third object, the display-output of the third object on the screen is restricted. According to the present invention, it becomes possible to express a state in which a part of a foot (boot) of a player is hidden by turf growing on a field by, for example, setting an object representing the field as “first object”, setting an object representing the foot (boot) of a soccer player as “second object”, and setting an object representing the turf as “third object”. In addition, according to the present invention, it becomes possible to alleviate processing load in a case of performing such an expression as described above.

Further, according to a yet further aspect of the present invention, the second object may be a three-dimensional object, and the restricting means may restrict the display-output of the third object on the screen by including the entirety or a part of the third object in the second object.

Further, according to a yet further aspect of the present invention, the restricting means may restrict the display-output of the third object on the screen by reducing a size of the third object.

Further, according to a yet further aspect of the present invention, the image processing device may include means for storing third object control data obtained by associating a condition regarding the posture of the second object or the third object with position controlling information regarding position control of a vertex of the third object, and the restricting means may control the position of the vertex of the third object based on the position controlling information corresponding to the condition satisfied by a current posture of the second object or the third object.

Further, according to a yet further aspect of the present invention, the image processing device may include means for storing second object control data for specifying a posture of the second object in each frame in a case where the second object moves, means for storing third object control data for specifying a position of a vertex of the third object in each frame in the case where the second object moves, and means for changing the posture of the second object by reproducing the second object control data in the case where the second object moves, and the restricting means may control the position of the vertex of the third object by reproducing the third object control data in synchronization with the reproducing of the second object control data.

Further, according to a yet further aspect of the present invention, the restricting means may restrict the display-output of the third object on the screen by increasing a transparency of the entirety or a part of the third object.

Further, according to a yet further aspect of the present invention, the image processing device may include means for storing third object control data obtained by associating a condition regarding the posture of the second object or the third object with transparency controlling information regarding transparency control of each point of the third object, and the restricting means may control the transparency of each point of the third object based on the transparency controlling information corresponding to the condition satisfied by a current posture of the second object or the third object.

Further, according to a yet further aspect of the present invention, the image processing device may include means for storing second object control data for specifying a posture of the second object in each frame in a case where the second object moves, means for storing third object control data for specifying a transparency of each point of the third object in each frame in the case where the second object moves, and means for changing the posture of the second object by reproducing the second object control data in the case where the second object moves, and the restricting means may control the transparency of each point of the third object by reproducing the third object control data in synchronization with the reproducing of the second object control data.

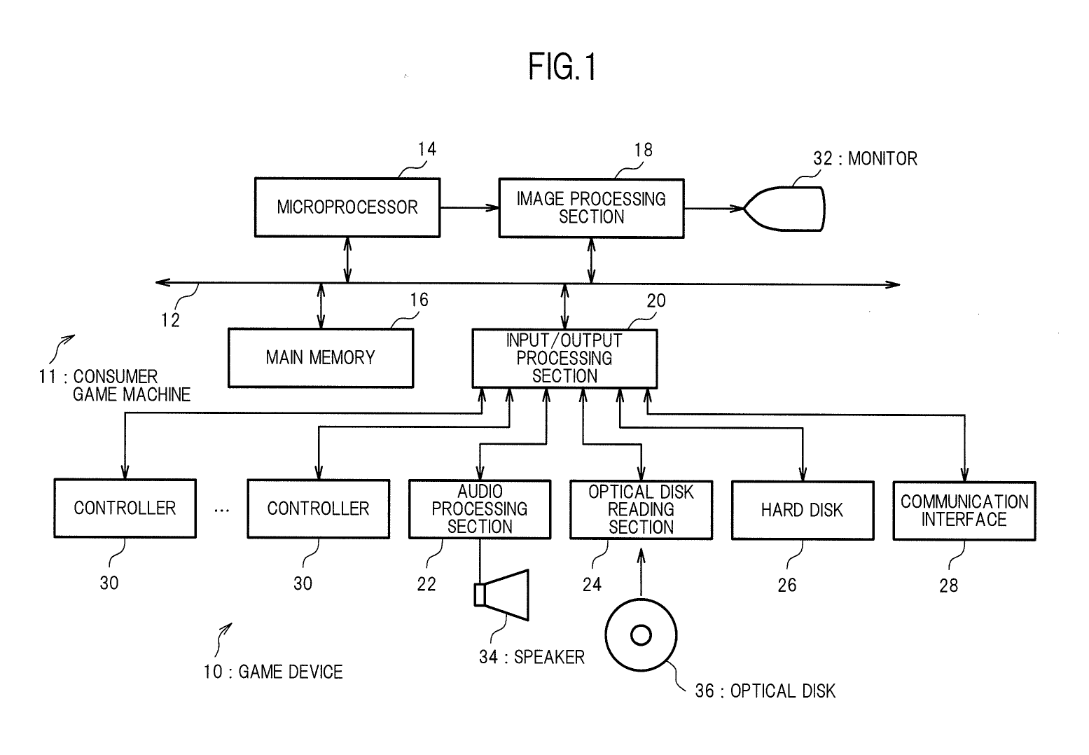

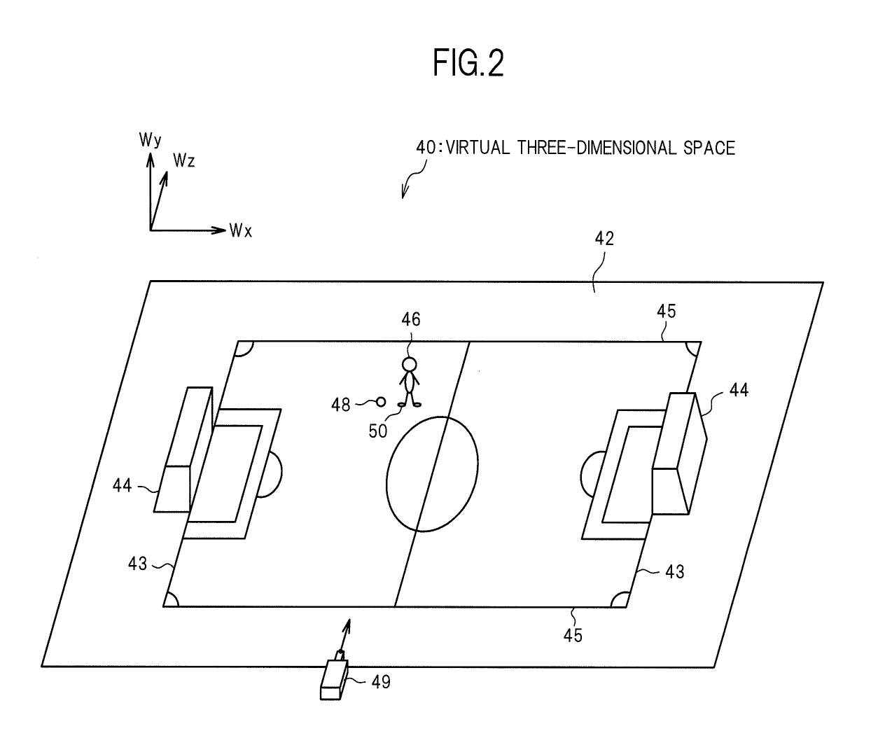

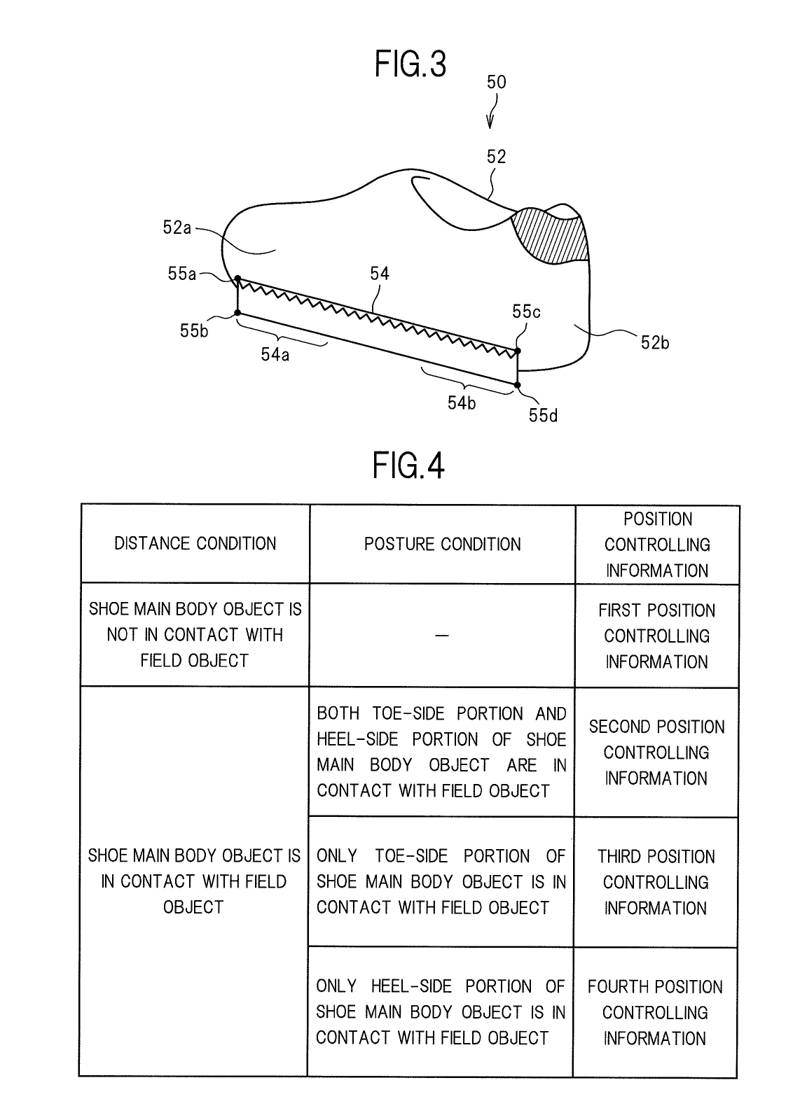

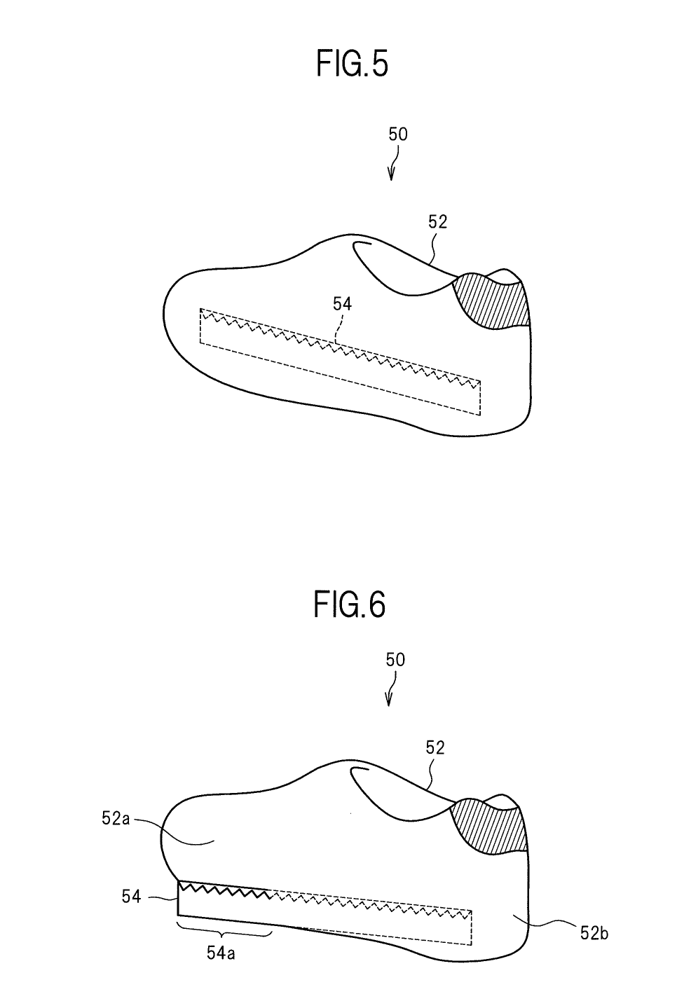

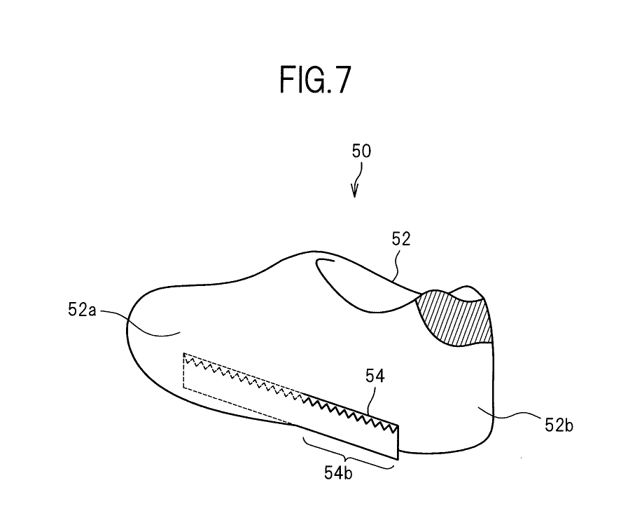

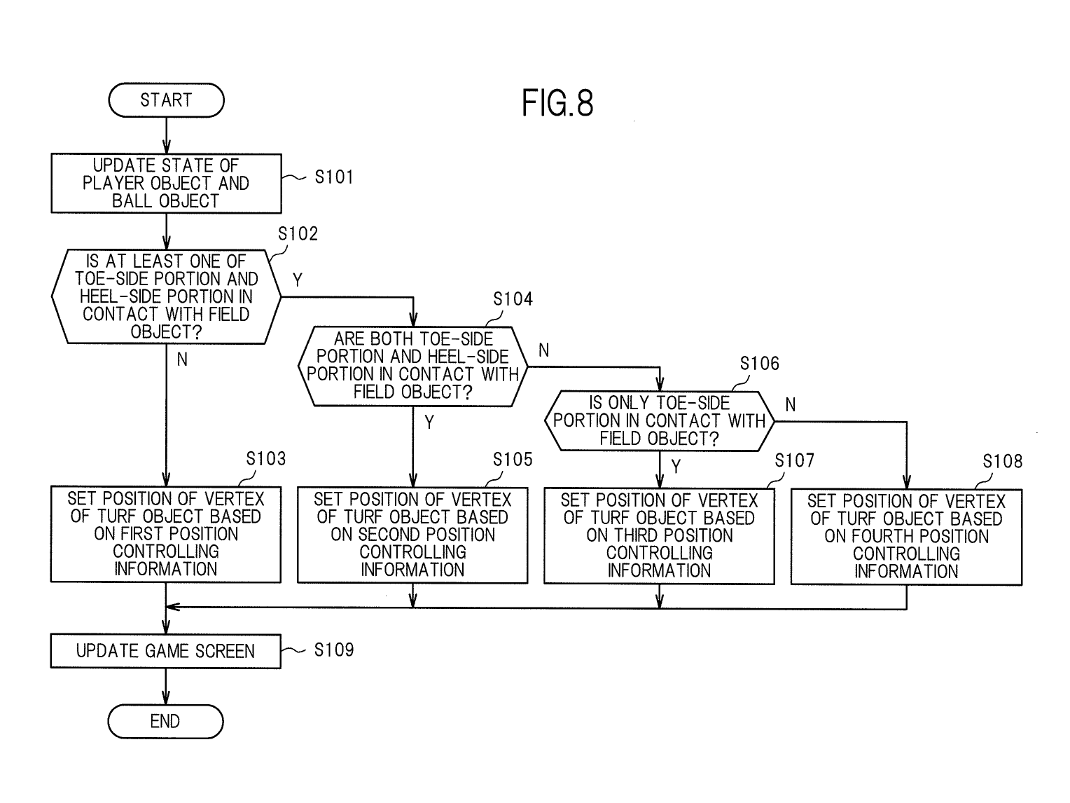

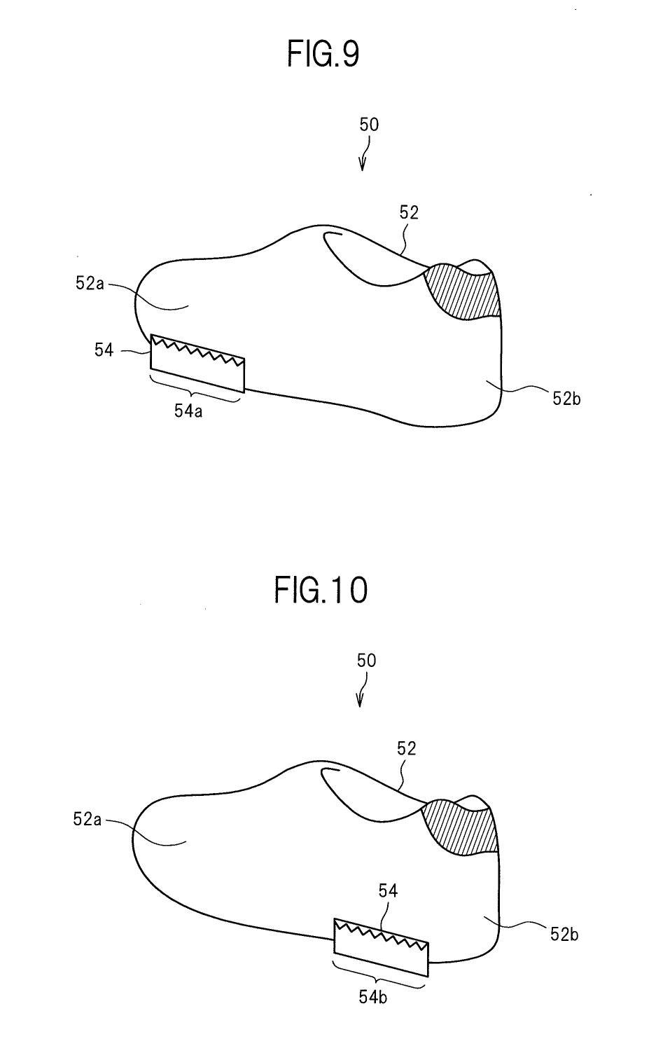

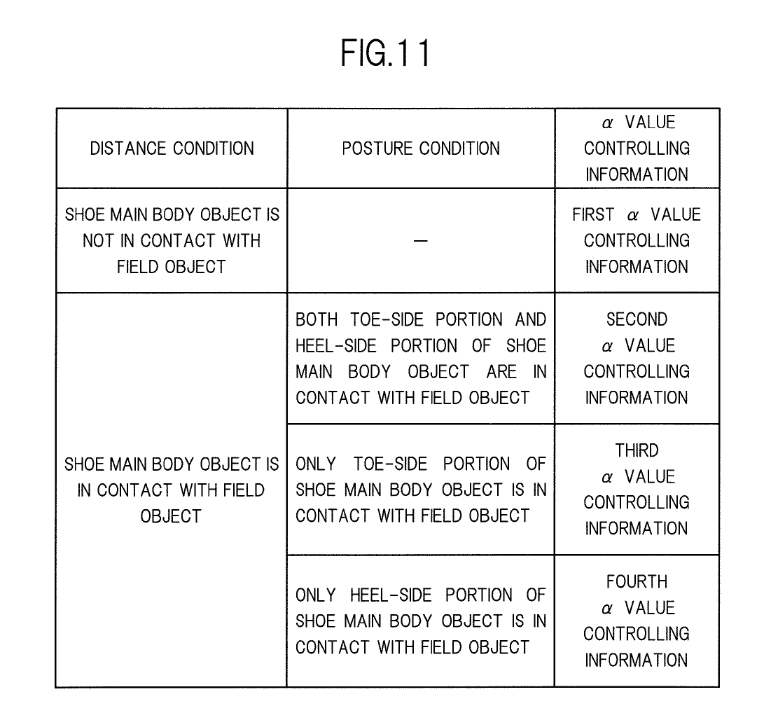

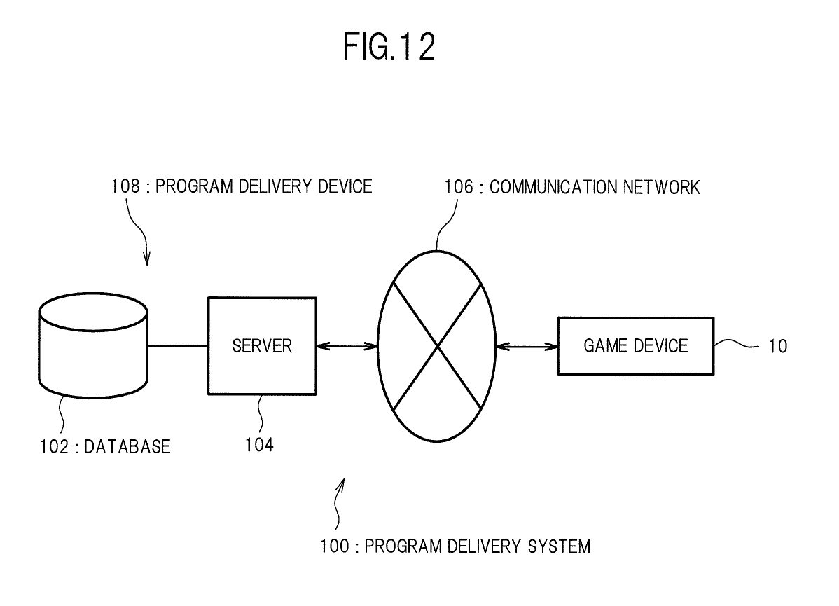

### BRIEF DESCRIPTION OF THE DRAWINGS

[FIG. 1] A diagram illustrating a hardware configuration of a game device according to an embodiment of the present invention.

[FIG. 2] A diagram illustrating an example of a virtual three-dimensional space.

[FIG. 3] A diagram illustrating an example of a shoe object.

[FIG. 4] A diagram illustrating an example of turf object control data.

[FIG. 5] A diagram illustrating an example of a state of the shoe object.

[FIG. 6] A diagram illustrating an example of the state of the shoe object.

[FIG. 7] A diagram illustrating an example of the state of the shoe object.

[FIG. 8] A flowchart illustrating processing executed by the game device.

[FIG. 9] A diagram illustrating an example of the state of the shoe object.

[FIG. 10] A diagram illustrating an example of the state of the shoe object.

[FIG. 11] A diagram illustrating an example of the turf object control data.

[FIG. 12] A diagram illustrating an overall configuration of a program delivery system according to another embodiment of the present invention.

### BEST MODE FOR CARRYING OUT THE INVENTION

Hereinafter, detailed description is given of an example of embodiments of the present invention based on the figures. Here, the description is directed to a case where the present invention is applied to a game device that is one aspect of an image processing device. The game device according to the embodiments of the present invention is implemented by, for example, a consumer game machine (stationary game machine), a portable game machine, a mobile phone, a personal digital assistant (PDA), a personal computer, or the like. Here, the description is given of the case where the game device according to the embodiments of the present invention is implemented by the consumer game machine. Note that the present invention can be applied to an image processing device other than the game device.

### FIRST EMBODIMENT

FIG. 1 illustrates an overall configuration of the game device (image processing device) according to a first embodiment of the present invention. A game device 10 illustrated in FIG. 1 includes a consumer game machine 11, a monitor 32, a speaker 34, and an optical disk 36 (information storage medium). The monitor 32 and the speaker 34 are connected to the consumer game machine 11. For example, a household television set is used as the monitor 32, and a speaker built into the household television set is used as the speaker 34.

The consumer game machine 11 is a well-known computer game system. The consumer game machine 11 includes a bus 12, a microprocessor 14, a main memory 16, an image processing section 18, an input/output processing section 20, an audio processing section 22, an optical disk reading section 24, a hard disk 26, a communication interface 28, and controllers 30. The constituent components other than the controllers 30 are accommodated in a casing of the consumer game machine 11.

The microprocessor 14 controls each of the sections of the consumer game machine 11 based on an operating system stored in a ROM (not shown) and on a program read out from the optical disk 36 or the hard disk 26. The main memory 16 includes, for example, a RAM. The program and data read out from the optical disk 36 or the hard disk 26 are written in the main memory 16 as necessary. The main memory 16 is also used as a working memory of the microprocessor 14. The bus 12 is for exchanging addresses and data among the sections of the consumer game machine 11. The microprocessor 14, the main memory 16, the image processing section 18, and the input/output processing section 20 are connected via the bus 12 so as to communicate data with one another.

The image processing section 18 includes a VRAM, and renders a game screen in the VRAM, based on image data sent from the microprocessor 14. Then, the image processing section 18 converts the game screen rendered in the VRAM into video signals and outputs the video signals to the monitor 32 at predetermined timings. That is, the image processing section 18 receives vertex coordinates in a viewpoint coordinate system, vertex color information (RGB value), texture coordinates, an alpha value, and the like of each polygon from the microprocessor 14. Then, those information items are used to draw color information, a Z value (depth information), the alpha value, and the like of each of pixels composing a display image in a buffer for display of the VRAM. At this time, a texture image is previously written in the VRAM, and a region within the texture image specified by respective texture coordinates is set to be mapped (pasted) to the polygon specified by the vertex coordinates corresponding to those texture coordinates. The thus-generated display image is output to the monitor 32 at the predetermined timing.

The input/output processing section 20 is an interface provided for the microprocessor 14 to access the audio processing section 22, the optical disk reading section 24, the hard disk 26, the communication interface 28, and the controllers 30. The audio processing section 22 includes a sound buffer, reproduces various audio data such as game music, a game sound effect, or a message read out from the optical disk 36 or the hard disk 26 to the sound buffer, and outputs the audio data from the speaker 34. The communication interface 28 is an interface for wired or wireless connection of the consumer game machine 11 to a communication network such as the Internet.

The optical disk reading section 24 reads the program or data recorded on the optical disk 36. In this case, the optical disk 36 is employed for providing the program or data to the consumer game machine 11, but any other information storage media such as a memory card may also be used. Further, the program or data may also be provided to the consumer game machine 11 from a remote location via a communication network such as the Internet. The hard disk 26 is a general hard disk device (auxiliary storage device).

The controllers 30 are versatile operation input units provided for a user to input various game operations. The input/output processing section 20 scans a state of each of the controllers 30 at predetermined intervals (e.g., every 1/60^{th} of a second), and passes an operation signal indicative of the result of scanning to the microprocessor 14 via the bus 12. The microprocessor 14 determines a game operation made by a player based on the operation signal. Note that the controllers 30 may be connected in a wired or wireless manner to the consumer game machine 11.

On the game device 10, for example, a soccer game is executed by a program read out from the optical disk 36 or the hard disk 26.

A virtual three-dimensional space is built in the main memory 16. FIG. 2 illustrates an example of the virtual three-dimensional space. As illustrated in FIG. 2, a field object 42 (first object) representing a soccer field is located in a virtual three-dimensional space 40. Goal objects 44 each representing a goal, a player object 46 representing a soccer player, and a ball object 48 representing a soccer ball are located on the field object 42. The player object 46 acts within the virtual three-dimensional space 40 according to a user's operation or a predetermined algorithm, and the ball object 48 moves within the virtual three-dimensional space 40 according to the user's operation or a predetermined algorithm. Although omitted from FIG. 2, twenty-two player objects 46 are located on the field object 42. In addition, in FIG. 2, each object is simplified.

The texture image is mapped to each object. For example, texture images describing the grain of the turf a goal line 43, a touch line 45, and the like are mapped to the field object 42. In addition, for example, a texture image describing a face of the soccer player, a texture image describing shoes, and other such texture image are mapped to the player object 46.

Positions of respective vertices of the player object 46 (that is, respective vertices of a plurality of polygons that compose the player object 46) are managed in a local coordinate system in which a representative point of the player object 46 is set as an origin point. Note that a position of the representative point of the player object 46 is managed in a world coordinate system (WxWyWz coordinate system illustrated in FIG. 2). A world coordinate value of each vertex of the player object 46 is specified based on a world coordinate value of the representative point and a local coordinate value of each vertex. The same is true of a position of each vertex of the ball object 48.

A plurality of skeletons are set within the player object 46. The plurality of skeletons include joints corresponding to joint portions and bones connecting the joints to each other. Each of joints and bones is associated with at least some of the vertices of the polygon that is a component of the player object 46. If there is a change in state (including a rotation angle and a position) of the joints and the bones, the vertices associated with the joints and the bones move based on a state change of the joints and the bones, with the result that a posture of the player object 46 is caused to change.

A virtual camera 49 (viewpoint) is also set in the virtual three-dimensional space 40. For example, the virtual camera 49 moves in the virtual three-dimensional space 40 based on the movement of the ball object 48. A game screen representing a state of the virtual three-dimensional space 40 viewed from this virtual camera 49 is displayed on the monitor 32. The user operates the player object 46 while watching the game screen, with the aim of causing a scoring event for their own team to take place.

Hereinafter, description is given of technology for alleviating processing load in a case of expressing a state in which a part of a foot (boot) of the soccer player is hidden by turf growing on the field in the above-mentioned soccer game.

FIG. 3 is a diagram illustrating an example of a shoe object (boot object) 50 representing a shoe (boot) worn by the player object 46 according to the embodiment. As illustrated in FIG. 3, the shoe object 50 includes a shoe main body object 52 (second object) and a turf object 54 (third object). The shoe main body object 52 is a three-dimensional object, and the shoe main body object 52 is hollow inside. The turf object 54 is an object for performing display-output related to the field object 42, and is an object for expressing the turf growing on the field. The turf object 54 is a plate-like object, and is located perpendicularly to an undersurface of the shoe main body object 52. The turf object 54 is located in a position based on the shoe main body object 52, and moves according to the movement of the shoe main body object 52. The positions of the respective vertices of the shoe main body object 52 and the turf object 54 (that is, respective vertices of polygons that are components of the shoe main body object 52 and the turf object 54) are managed in the local coordinate system. Note that hereinbelow, a portion 54a of the turf object 54, which corresponds to a toe-side portion 52a of the shoe main body object 52, is referred to as “first portion”. Further, a portion 54b of the turf object 54, which corresponds to a heel-side portion 52b of the shoe main body object 52, is referred to as “second portion”.

In a case where the player object 46 performs an action such as running, the shoe main body object 52 moves while coming into contact with the field object 42 or lifting away from the field object 42. That is, the shoe main body object 52 moves so as to cause a distance from the field object 42 to change. In the embodiment, according to the movement of the shoe main body object 52, a limitation is imposed on the display-output of the turf object 54 on the game screen, or the limitation is removed. In other words, according to a change of a height from the field object 42 to the shoe main body object 52 (or turf object 54), the display-output of the turf object 54 on the game screen is restricted, or the restriction is removed. For example, in a case where the shoe main body object 52 is not in contact with the field object 42, the turf object 54 is not displayed on the game screen. Alternatively, for example, in a case where the shoe main body object 52 is in contact with the field object 42, the entirety or a part of the turf object 54 is displayed on the game screen.

Further, in this embodiment, based on a posture of the shoe main body object 52 (or turf object 54), the display-output of the portion of the turf object 54 on the game screen is restricted, or the restriction is removed. For example, in a case where the posture of the shoe main body object 52 is such a posture that only the toe-side portion 52a is in contact with the field object 42, portions other than the first portion 54a of the turf object 54 are not displayed on the game screen. Alternatively, for example, in a case where the posture of the shoe main body object 52 is such a posture that only the heel-side portion 52b is in contact with the field object 42, portions other than the second portion 54b of the turf object 54 are not displayed on the game screen. Alternatively, for example, in a case where the posture of the shoe main body object 52 is such a posture that the toe-side portion 52a and the heel-side portion 52b are in contact with the field object 42, the entire turf object 54 is displayed on the game screen.

Here, description is given of data stored on the game device 10. For example, information indicating the current position of the player object 46 is stored in the main memory 16. More specifically, the world coordinate value of the representative point of the player object 46 and the local coordinate value of each vertex of the player object 46 are stored.

In addition, motion data for causing the player object 46 to perform various actions are stored on the optical disk 36 or the hard disk 26. The motion data is data that defines a change of the position (local coordinate value) of the vertex of the player object 46 in each frame (for example, every 1/60^{th} of a second) in a case where the player object 46 performs various actions. The motion data can also be understood as data that defines a change of the posture of the player object 46 in each frame in the case where the player object 46 performs various actions. For example, the motion data is data that defines the state change of each skeleton in each frame in the case where the player object 46 performs various actions. The game device 10 causes the player object 46 to perform various actions by changing the position of the vertex of the player object 46 according to the motion data. Note that hereinafter, the changing of the position of the vertex of the player object 46 according to the motion data is referred to as “reproducing the motion data”. The running motion data (second object control data), for example, is stored as the motion data. The running motion data is motion data for causing the player object 46 to perform an action of running while alternatively raising both feet, and is reproduced when the player object 46 moves.

In addition, the turf object control data (third object control data) is stored on the optical disk 36 or the hard disk 26. The turf object control data is data obtained by associating a distance condition regarding the distance between the shoe object 50 (shoe main body object 52 or turf object 54) and the field object 42 with position controlling information regarding position control of each vertex of the turf object 54. Alternatively, the turf object control data is data obtained by associating the posture condition regarding the posture of the shoe object 50 (shoe main body object 52 or turf object 54) with the above-mentioned position controlling information.

FIG. 4 illustrates an example of the turf object control data. The turf object control data illustrated in FIG. 4 is data obtained by associating a combination of a “distance condition” and a “posture condition” with “position controlling information”. The “distance condition” of FIG. 4 is a condition as to whether or not the shoe main body object 52 is in contact with the field object 42. Note that here, the “distance condition” is a condition regarding a distance between the shoe main body object 52 and the field object 42, but the turf object 54 moves according to the movement of the shoe main body object 52, and hence the “distance condition” may be set as a condition regarding a distance between the turf object 54 and the field object 42. The “posture condition” is a condition regarding the posture of the shoe main body object 52. The “posture condition” of FIG. 4 is a condition as to what kind of posture is taken by the shoe main body object 52 which is in contact with the field object 42. Note that here, the “posture condition” is a condition regarding the posture of the shoe main body object 52, but the turf object 54 is located perpendicularly to the undersurface of the shoe main body object 52 (that is, there is a fixed relationship between posture of the turf object 54 and posture of the shoe main body object 52), and hence the “posture condition” may be set as a condition regarding the posture of the turf object 54. In addition, the “position controlling information” of FIG. 4 is, for example, information for acquiring the local coordinate value of each vertex of the turf object 54. For example, information indicating a position of each vertex of the turf object 54 relative to the shoe main body object 52 (representative point and representative orientation of the shoe main body object 52) in the local coordinate system of the player object 46 is stored as the “position controlling information”.

The turf object control data illustrated in FIG. 4 defines the position controlling information for a case where the shoe main body object 52 is not in contact with the field object 42 and for a case where the shoe main body object 52 is in contact with the field object 42. FIG. 5 to FIG. 7 are figures used for describing contents of the position controlling information. Note that in FIG. 5 to FIG. 7, a portion of the turf object 54 represented by the dotted line indicates that the portion exists inside the shoe main body object 52.

With the position controlling information (first position controlling information) for the case where the shoe main body object 52 is not in contact with the field object 42, the position of each vertex of the turf object 54 is set so that the entirety of the turf object 54 exists inside the shoe main body object 52 (see FIG. 5).

Meanwhile, as the position controlling information for the case where the shoe main body object 52 is in contact with the field object 42, the position controlling information corresponding to three kinds of posture of the shoe main body object 52 are defined for: a case (1) where both the toe-side portion 52a and the heel-side portion 52b of the shoe main body object 52 are in contact with the field object 42; a case (2) where only the toe-side portion 52a of the shoe main body object 52 is in contact with the field object 42; and a case (3) where only the heel-side portion 52b of the shoe main body object 52 is in contact with the field object 42.

With the position controlling information (second position controlling information) for the case where both the toe-side portion 52a and the heel-side portion 52b of the shoe main body object 52 are in contact with the field object 42, the position of each vertex of the turf object 54 is set so that the entirety of the turf object 54 is caused to exist outside the shoe main body object 52 (see FIG. 3).

With the position controlling information (third position controlling information) for the case where only the toe-side portion 52a of the shoe main body object 52 is in contact with the field object 42, the position of each vertex of the turf object 54 is set so that only the first portion 54a (portion corresponding to the toe-side portion 52a) of the turf object 54 is caused to exist outside the shoe main body object 52 (see FIG. 6).

With the position controlling information (fourth position controlling information) for the case where only the heel-side portion 52b of the shoe main body object 52 is in contact with the field object 42, the position of each vertex of the turf object 54 is set so that only the second portion 54a (portion corresponding to the heel-side portion 52b) of the turf object 54 is caused to exist outside the shoe main body object 52 (see FIG. 7).

Next, description is given of processing executed by the game device 10. FIG. 8 is a flowchart mainly illustrating the processing related to the present invention among various processing executed by the game device 10 every predetermined time (for example, 1/60 seconds). The microprocessor 14 executes the processing illustrated in FIG. 8 according to a program stored on the optical disk 36 or the hard disk 26.

As illustrated in FIG. 8, the microprocessor 14 updates states of each of the player objects 46 and the ball object 48 (S101). For example, the world coordinate values of the representative points of each of the player objects 46 and the ball object 48 are updated according to a player's operation or a predetermined algorithm. Further, for example, the state (rotation angle and position) of the skeleton of the player object 46 is updated according to the motion data. That is, a state of the skeleton in the current frame is acquired from the motion data, and the state of the skeleton of the player object 46 is set to the thus-acquired state. As a result, the local coordinate value of each vertex of the player object 46 is updated as well. Note that the position (local coordinate value) of each vertex of the turf object 54 is updated by processing (S102 to S108) described below.

After execution of the processing of Step S101, the microprocessor 14 (limitation means) executes the processing (S102 to S108) described below on each of the player objects 46. In addition, the processing (S102 to S108) described below is executed respectively on both the turf object 54 associated with the shoe main body object 52 corresponding to a left foot and the turf object 54 associated with the shoe main body object 52 corresponding to a right foot.

First, the microprocessor 14 judges whether or not at least one of the toe-side portion 52a and the heel-side portion 52b of the shoe main body object 52 is in contact with the field object 42 (S102). In the processing of this step, it is judged whether or not a first reference point set in the undersurface of the toe-side portion 52a is in contact with the field object 42. Specifically, it is judged whether or not a distance between the first reference point and the field object 42 (that is, distance between the first reference point and a foot of a perpendicular extending from the first reference point to the field object 42) is zero. If the distance is zero, it is judged that the first reference point is in contact with the field object 42, and if the distance is larger than zero, it is judged that the first reference point is not in contact with the field object 42. Then, if the first reference point is in contact with the field object 42, it is judged that the toe-side portion 52a is in contact with the field object 42. Note that if the first reference point is close enough to the field object 42, it may be judged that the toe-side portion 52a is in contact with the field object 42. That is, it may be judged whether or not the distance between the first reference point and the field object 42 is equal to or smaller than a predetermined distance. Then, if the distance between the first reference point and the field object 42 is equal to or smaller than the predetermined distance, it may be judged that the toe-side portion 52a is in contact with the field object 42, and if the distance between the first reference point and the field object 42 is larger than the predetermined distance, it may be judged that the toe-side portion 52a is not in contact with the field object 42. In the processing of Step S102, it is also judged whether or not a second reference point set in the undersurface of the heel-side portion 52b is in contact with the field object 42. This judgment is executed in the same manner as in the case of judging whether or not the first reference point is in contact with the field object 42. Then, if the second reference point is in contact with the field object 42, it is judged that the heel-side portion 52b is in contact with the field object 42.

If it is not judged that at least one of the toe-side portion 52a and the heel-side portion 52b of the shoe main body object 52 is in contact with the field object 42, the microprocessor 14 sets the position of each vertex of the turf object 54 based on the first position controlling information (S103). As described above, the position controlling information is information indicating a position of each vertex of the turf object 54 relative to the shoe main body object 52 (representative point and representative orientation of the shoe main body object 52) in the local coordinate system of the player object 46. Therefore, in the processing of this step, the local coordinate value of each vertex of the turf object 54 is specified based on the first position controlling information, the local coordinate value of the representative point of the shoe main body object 52, and the representative orientation of the shoe main body object 52. Note that if the processing of this step is executed, the entirety of the turf object 54 is caused to exist inside the shoe main body object 52 (see FIG. 5). As a result, if the shoe main body object 52 is not in contact with the field object 42, a limitation is imposed on the display-output of the turf object 54 on the game screen. That is, the turf object 54 is not displayed on the game screen.

Meanwhile, if it is judged that at least one of the toe-side portion 52a and the heel-side portion 52b of the shoe main body object 52 is in contact with the field object 42, the microprocessor 14 judges whether or not both the toe-side portion 52a and the heel-side portion 52b are in contact with the field object 42 (S104). In the processing of this step, it is judged whether or not both the first reference point and the second reference point described above are in contact with the field object 42. If both the first reference point and the second reference point are in contact with the field object 42, it is judged that both the toe-side portion 52a and the heel-side portion 52b are in contact with the field object 42.

If it is judged that both the toe-side portion 52a and the heel-side portion 52b of the shoe main body object 52 are in contact with the field object 42, the microprocessor 14 sets the position of each vertex of the turf object 54 based on the second position controlling information (S105). In this case, the entirety of the turf object 54 is caused to exist outside the shoe main body object 52 (see FIG. 3). As a result, with regard to the entirety of the turf object 54, the limitation of the display-output is removed. That is, the entirety of the turf object 54 is displayed on the game screen, and a state in which the shoe of the soccer player is hidden by the turf is expressed on the game screen.

Meanwhile, if it is not judged that both the toe-side portion 52a and the heel-side portion 52b of the shoe main body object 52 are in contact with the field object 42, that is, if it is judged that any one of the toe-side portion 52a and the heel-side portion 52b is not in contact with the field object 42, the microprocessor 14 judges whether or not only the toe-side portion 52a is in contact with the field object 42 (S106). In the processing of this step, it is judged whether or not the above-mentioned first reference point is in contact with the field object 42. Then, if it is judged that the first reference point is in contact with the field object 42, it is judged that only the toe-side portion 52a is in contact with the field object 42.

If it is judged that only the toe-side portion 52a of the shoe main body object 52 is in contact with the field object 42, the microprocessor 14 sets the position of each vertex of the turf object 54 based on the third position controlling information (S107). In this case, the first portion 54a of the turf object 54 is caused to exist outside the shoe main body object 52 (see FIG. 6). As a result, with regard to the first portion 54a of the turf object 54, the limitation of the display-output is removed. That is, the first portion 54a (portion corresponding to the toe-side portion 52a) of the turf object 54 is displayed on the game screen, and a state in which a toe portion of the shoe of the soccer player is hidden by the turf is expressed on the game screen.

If it is judged in Step S106 that the toe-side portion 52a of the shoe main body object 52 is not in contact with the field object 42, the microprocessor 14 judges that only the heel-side portion 52b of the shoe main body object 52 is in contact with the field object 42. Then, the microprocessor 14 sets the position of each vertex of the turf object 54 based on the fourth position controlling information (S108). In this case, only the second portion 54b of the turf object 54 is caused to exist outside the shoe main body object 52 (see FIG. 7). As a result, with regard to the second portion 54b of the turf object 54, the limitation of the display-output is removed. That is, the second portion 54b (portion corresponding to the heel-side portion 52b) of the turf object 54 is displayed on the game screen, and a state in which a heel portion of the shoe of the soccer player is hidden by the turf is expressed on the game screen.

After execution of the processing of Steps S102 to S108, the microprocessor 14 and the image processing section 18 update the game screen (S109). In the processing of this step, based on the world coordinate value of the representative point of the player object 46, the local coordinate value of each vertex of the player object 46 (including the turf object 54), and the like, an image representing a state of the virtual three-dimensional space 40 viewed from the virtual camera 49 is generated in the VRAM. The image generated in the VRAM is displayed as the game screen on the monitor 32. Incidentally, at this time, it is preferable that a color of the turf object 54 be set based on a color at a position on the field object 42 corresponding to a position where the turf object 54 (or shoe main body object 52, shoe object 50, or player object 46) is located. A difference between the color of the turf object 54 and a color of the field object 42 in the vicinity of the turf object 54 may make the user feel uneasy, but the above-mentioned arrangement makes it possible to prevent this feeling.

Note that in the processing of Step S102, S104, or S106, it may be judged whether or not the toe-side portion 52a or the heel-side portion 52b of the shoe main body object 52 is in contact with the field object 42 based on the state (the rotation angle or the like) of a foot skeleton set inside the shoe main body object 52. In this aspect, the “posture condition” in the turf object control data can be assumed as a condition regarding the state of the foot skeleton.

Incidentally, the turf object control data may be set as data defining a change of the position (local coordinate value) of each vertex of the turf object 54 in each frame in a case where the player object 46 performs various actions (for example, running action). In other words, the turf object control data may be set as data defining a change of the position of each vertex of the turf object 54 in each frame in a case where various kinds of motion data (for example, running motion data) are reproduced.

In this case, for example, in a frame in which the player object 46 is raising its right foot (that is, frame in which the right foot of the player object 46 is not in contact with a ground), the position of each vertex of the turf object 54 associated with the shoe main body object 52 corresponding to the right foot is set so that the entirety of the turf object 54 is caused to exist inside the shoe main body object 52 corresponding to the right foot (see FIG. 5).

Further, for example, in a frame in which the toe and the heel of the right foot of the player object 46 are in contact with the ground, the position of each vertex of the turf object 54 associated with the shoe main body object 52 corresponding to the right foot is set so that the entirety of the turf object 54 is located outside the shoe main body object 52 corresponding to the right foot (see FIG. 3).

Further, for example, in a frame in which the toe of the right foot of the player object 46 is in contact with the ground with the heel thereof not being in contact with the ground, the position of each vertex of the turf object 54 associated with the shoe main body object 52 corresponding to the right foot is set so that the first portion 54a of the turf object 54 is located outside the shoe main body object 52 corresponding to the right foot and that the other portion is located inside the shoe main body object 52 corresponding to the right foot (see FIG. 6).

Further, for example, in a frame in which the heel of the right foot of the player object 46 is in contact with the ground with the toe thereof not being in contact with the ground, the position of each vertex of the turf object 54 associated with the shoe main body object 52 corresponding to the right foot is set so that the second portion 54b of the turf object 54 is located outside the shoe main body object 52 corresponding to the right foot and that the other portion is located inside the shoe main body object 52 corresponding to the right foot (see FIG. 7).

The turf object control data as described above is, for example, prepared for each motion data item and stored in association with each motion data item. Alternatively, the motion data and the turf object control data may be provided as integral data.

Further, the turf object control data as described above is reproduced in synchronization with the reproduction of the motion data. That is, the position of each vertex of the turf object 54 is changed according to the turf object control data in synchronization with the state of the foot skeleton of the player object 46 (in other words, position of each vertex of the shoe main body object 52 or posture of the shoe main body object 52) being changed according to the motion data. For example, in the processing illustrated in FIG. 8, such processing as described below is executed in place of the processing of Steps S102 to S108. That is, the position of each vertex of the turf object 54 in the current frame is specified from the turf object control data, and the position of each vertex of the turf object 54 is set. Note that even in such a case, it may be confirmed whether or not the shoe main body object 52 is in contact with the field object 42, and the limitation may be imposed on the display-output of the entirety or a part of the turf object 54 based on a result of the confirmation. This can prevent, for example, the turf object 54 from being displayed in a state in which the shoe main body object 52 is not in contact with the field object 42.

On the game device 10 according to the first embodiment, the turf object 54 moves according to the movement of the shoe main body object 52. According to the game device 10, it becomes possible to express the state in which apart of the shoe (foot) of the soccer player is hidden by the turf growing on the field without locating a large number of turf objects in the entirety of the field object 42. That is, according to the game device 10, it becomes possible to reduce the number of turf objects located in the virtual three-dimensional space 40. As a result, it becomes possible to alleviate processing load in the case of expressing the state in which a part of the shoe (foot) of the soccer player is hidden by the turf growing on the field.

Further, on the game device 10, the limitation is imposed on the display-output of the turf object 54 based on the distance between the shoe object 50 (shoe main body object 52 or turf object 54) and the field object 42. For example, if the shoe main body object 52 is not in contact with the field object 42, the turf object 54 is not displayed on the game screen. If the turf is displayed in the vicinity of the foot (shoe) regardless of the distance between the foot (shoe) of the soccer player and the field being large, the user is made to feel uneasy. In this respect, according to the game device 10, it becomes possible to ensure that the user is not made to feel uneasy in the above-mentioned manner.

Further, on the game device 10, the limitation is imposed on the display-output of a part of the turf object 54 based on what kind of posture is taken by the shoe main body object 52 which is in contact with the field object 42. For example, if only the toe-side portion 52a of the shoe main body object 52 is in contact with the field object 42, only the first portion 54a of the turf object 54 corresponding to the toe-side portion 52a is displayed on the game screen, and the other portion is not displayed on the game screen. In the same manner, if only the heel-side portion 52b of the shoe main body object 52 is in contact with the field object 42, only the second portion 54b of the turf object 54 corresponding to the heel-side portion 52b is displayed on the game screen, and the other portion is not displayed on the game screen. That is, a portion of the turf object 54 corresponding to a portion of the shoe main body object 52 which is not in contact with the field object 42 is not displayed on the game screen. If the turf is displayed in the vicinity of a portion of the foot (shoe) of the soccer player which is not in contact with the field, the user is made to feel uneasy. In this respect, according to the game device 10, it becomes possible to ensure that the user is not made to feel uneasy in the above-mentioned manner.

Note that on the game device 10, the position of the turf object 54 is managed in the local coordinate system of the player object 46 in the same manner as the shoe main body object 52. Therefore, if the player object 46 moves (that is, if the world coordinate value of the representative point of the player object 46 is updated), the turf object 54 also moves according to the movement. That is, simplification of processing for moving the turf object 54 according to the movement of the player object 46 is achieved.

### SECOND EMBODIMENT

Next, description is given of a game machine according to a second embodiment of the present invention. A game device 10 according to the second embodiment has the same hardware configuration as that of the first embodiment (see FIG. 1). Also on the game device 10 according to the second embodiment, the virtual three-dimensional space 40 (see FIG. 2) which is the same as that of the first embodiment is built in the main memory 16.

Further, also in the second embodiment, the shoe object 50 includes the shoe main body object 52 and the turf object 54 in the same manner as in the first embodiment. In the first embodiment, by locating the entirety or a part of the turf object 54 inside the shoe main body object 52, the display-output of the turf object 54 on the game screen is restricted. In this respect, the second embodiment is different from the first embodiment in that the display-output of the turf object 54 on the game screen is restricted by changing a size (height and/or width) of the turf object 54.

Also in the second embodiment, the information indicating the current position of the player object 46 is stored in the main memory 16. In addition, the motion data on the player object 46 is stored on the optical disk 36 or the hard disk 26.

Further, also in the second embodiment, the turf object control data is stored in the same manner as in the first embodiment. The turf object control data is, for example, the same data as the turf object control data illustrated in FIG. 4. FIG. 9 and FIG. 10 are diagrams for describing the position controlling information of the turf object control data according to the second embodiment.

For example, with the position controlling information (second position controlling information) for the case where both the toe-side portion 52a and the heel-side portion 52b of the shoe main body object 52 are in contact with the field object 42, the position of each vertex of the turf object 54 is set so that the height and width of the turf object 54 are a predetermined length (hereinafter, referred to as “basic length”) and a predetermined width (hereinafter, referred to as “basic width”), respectively (see FIG. 3).

With the position controlling information (third position controlling information) for the case where only the toe-side portion 52a of the shoe main body object 52 is in contact with the field object 42, the position of each vertex of the turf object 54 is set so that the height of the first portion 54a of the turf object 54 becomes the basic length, and that the height of the other portion becomes zero (see FIG. 9). Note that with the position controlling information (third position controlling information), the position of each vertex of the turf object 54 may be set so that the height of the turf object 54 becomes the basic length and that the width of the turf object 54 becomes a width shorter than the basic width. In this case, the width of the turf object 54 is reduced in such a manner that vertices (vertices 55c and 55d: see FIG. 3) of an edge on a side of the second portion 54b of the turf object 54 move toward vertices (vertices 55a and 55b: see FIG. 3) of an edge on a side of the first portion 54a.

With the position controlling information (fourth position controlling information) for the case where only the heel-side portion 52b of the shoe main body object 52 is in contact with the field object 42, the position of each vertex of the turf object 54 is set so that the height of the second portion 54b of the turf object 54 becomes the basic length, and that the height of the other portion becomes zero (see FIG. 10). Note that with the position controlling information (fourth position controlling information), the position of each vertex of the turf object 54 may be set so that the height of the turf object 54 becomes the basic length and that the width of the turf object 54 becomes a width shorter than the basic width. In this case, the width of the turf object 54 is reduced in such a manner that the vertices (vertices 55a and 55b: see FIG. 3) of the edge on the side of the first portion 54a of the turf object 54 move toward the vertices (vertices 55c and 55d: see FIG. 3) of the edge on the side of the second portion 54b.

With the position controlling information (first position controlling information) for the case where the shoe main body object 52 is not in contact with the field object 42, the position of each vertex of the turf object 54 is set so that the height and/or the width of the turf object 54 becomes zero.

The game device 10 according to the second embodiment also executes processing similar to the processing (see FIG. 8) which is executed by the game device 10 according to the first embodiment.

That is, in the processing of Step S103, the position of each vertex of the turf object 54 is set based on the first position controlling information. In this case, the height and/or the width of the turf object 54 becomes zero. As a result, if the shoe main body object 52 is not in contact with the field object 42, the limitation is imposed on the display-output of the turf object 54 on the game screen. That is, the turf object 54 is not displayed on the game screen.

Further, in the processing of Step S105, the position of each vertex of the turf object 54 is set based on the second position controlling information. In this case, the height and the width of the turf object 54 become the basic length and the basic width, respectively (see FIG. 3). As a result, if both the toe-side portion 52a and the heel-side portion 52b of the shoe main body object 52 are in contact with the field object 42, with regard to the entirety of the turf object 54, the limitation is not imposed on the display-output. That is, the entirety of the turf object 54 is displayed on the game screen, and the state in which the shoe of the soccer player is hidden by the turf is expressed on the game screen.

Further, in the processing of Step S107, the position of each vertex of the turf object 54 is set based on the third position controlling information. In this case, the height of the first portion 54a of the turf object 54 becomes the basic length, and the height of the other portion becomes zero (see FIG. 9). As a result, if the toe-side portion 52a of the shoe main body object 52 is in contact with the field object 42, the first portion 54a (portion corresponding to the toe-side portion 52a) of the turf object 54 is displayed on the game screen, and a limitation is imposed on the display-output of the other portion. That is, the state in which the toe portion of the shoe of the soccer player is hidden by the turf is expressed on the game screen.

Further, in the processing of Step S108, the position of each vertex of the turf object 54 is set based on the fourth position controlling information. In this case, the height of the second portion 54b of the turf object 54 becomes the basic length, and the height of the other portion becomes zero (see FIG. 10). As a result, if the heel-side portion 52b of the shoe main body object 52 is in contact with the field object 42, the second portion 54b (portion corresponding to the heel-side portion 52b) of the turf object 54 is displayed on the game screen, and a limitation is imposed on the display-output of the other portion. That is, the state in which the heel portion of the shoe of the soccer player is hidden by the turf is expressed on the game screen.

Note that in the same manner as in the first embodiment, also in the second embodiment, the turf object control data may be set as data defining the change of the position of each vertex of the turf object 54 in each frame in the case where the player object 46 performs various actions (for example, running action).

In this case, for example, in a frame in which the player object 46 is raising its right foot (that is, a frame in which the right foot of the player object 46 is not in contact with the ground), the position of each vertex of the turf object 54 associated with the shoe main body object 52 corresponding to the right foot is set so that the height and/or the width of the turf object 54 become zero.

Further, for example, in a frame in which the toe and the heel of the right foot of the player object 46 are in contact with the ground, the position of each vertex of the turf object 54 associated with the shoe main body object 52 corresponding to the right foot is set so that the height and the width of the turf object 54 become the basic length and the basic width, respectively (see FIG. 3).

Further, for example, in a frame in which the toe of the right foot of the player object 46 is in contact with the ground with the heel thereof not being in contact with the ground, the position of each vertex of the turf object 54 associated with the shoe main body object 52 corresponding to the right foot is set so that the height of the first portion 54a of the turf object 54 becomes the basic length, and that the height of the other portion becomes zero (see FIG. 9).

Further, for example, in a frame in which the heel of the right foot of the player object 46 is in contact with the ground with the toe thereof not being in contact with the ground, the position of each vertex of the turf object 54 associated with the shoe main body object 52 corresponding to the right foot is set so that the height of the second portion 54b of the turf object 54 becomes the basic length, and that the height of the other portion becomes zero (see FIG. 10).

In the same manner as the game device 10 according to the first embodiment, also with the game device 10 according to the second embodiment, it becomes possible to alleviate the processing load in the case of expressing the state in which a part of the foot (shoe) of the soccer player is hidden by the turf growing on the field. Further, also with the game device 10 according to the second embodiment, it becomes possible to ensure that the user is not made to feel uneasy due to the turf being displayed in the vicinity of the foot (shoe) regardless of the distance between the foot (shoe) of the soccer player and the field being large. Further, also with the game device 10 according to the second embodiment, it becomes possible to ensure that the user is not made to feel uneasy due to the turf being displayed in the vicinity of a portion of the foot (shoe) of the soccer player which is not in contact with the field.

### THIRD EMBODIMENT

Next, description is given of a game machine according to a third embodiment of the present invention. A game device 10 according to the third embodiment has the same hardware configuration as that of the first embodiment (see FIG. 1). Also on the game device 10 according to the third embodiment, the virtual three-dimensional space 40 (see FIG. 2) which is the same as that of the first embodiment is built in the main memory 16.

Further, also in the third embodiment, the shoe object 50 includes the shoe main body object 52 and the turf object 54 in the same manner as in the first embodiment. In the first embodiment, by locating the entirety or a part of the turf object 54 inside the shoe main body object 52, the display-output of the turf object 54 on the game screen is restricted. In this respect, the third embodiment is different from the first embodiment in that the display-output of the turf object 54 on the game screen is restricted by changing a transparency of the entirety or a part of the turf object 54.

Also in the third embodiment, the information indicating the current position of the player object 46 is stored in the main memory 16. In addition, the motion data on the player object 46 is stored on the optical disk 36 or the hard disk 26.

Further, also in the third embodiment, the turf object control data is stored in the same manner as in the first embodiment. However, the turf object control data according to the third embodiment is data obtained by associating the distance condition regarding the distance between the shoe object 50 (shoe main body object 52 or turf object 54) and the field object 42 with transparency controlling information regarding control of the transparency of each point (pixel or vertex) of the turf object 54. Alternatively, the turf object control data according to the third embodiment is data obtained by associating the posture condition regarding the posture of the shoe object 50 (shoe main body object 52 or turf object 54) with the above-mentioned transparency controlling information.

FIG. 11 illustrates an example of the turf object control data according to the third embodiment. The turf object control data illustrated in FIG. 11 is data obtained by associating the combination of the “distance condition” and the “posture condition” with “α value controlling information”. The “distance condition” and the “posture condition” of FIG. 11 are the same as the “distance condition” and the “posture condition” of the turf object control data according to the first embodiment (see FIG. 4). The “α value controlling information” is information for acquiring, for example, an α value (transparency) of each point of the turf object 54. For example, information indicating the α value of each point of the turf object 54 is stored as the “α value controlling information”.

The turf object control data illustrated in FIG. 11 defines the α value controlling information for the case where the shoe main body object 52 is not in contact with the field object 42 and the case where the shoe main body object 52 is in contact with the field object 42. Further, as the α value controlling information for the case where the shoe main body object 52 is in contact with the field object 42, the α value controlling information corresponding to three kinds of posture of the shoe main body object 52 are defined for the case (1) where both the toe-side portion 52a and the heel-side portion 52b of the shoe main body object 52 are in contact with the field object 42, the case (2) where only the toe-side portion 52a of the shoe main body object 52 is in contact with the field object 42, and the case (3) where only the heel-side portion 52b of the shoe main body object 52 is in contact with the field object 42.

In the α value controlling information (second α value controlling information) for the case where both the toe-side portion 52a and the heel-side portion 52b of the shoe main body object 52 are in contact with the field object 42, α values of all of points of the turf object 54 are set to a predetermined value (hereinafter, referred to as “basic value”) corresponding to complete opacity.

In the α value controlling information (third α value controlling information) for the case where only the toe-side portion 52a of the shoe main body object 52 is in contact with the field object 42, the α value of the first portion 54a of the turf object 54 is set to the basic value, and the α value of the other portion is set to a predetermined value (for example, value corresponding to complete transparency) indicating a transparency higher than the basic value.

In the α value controlling information (fourth α value controlling information) for the case where only the heel-side portion 52b of the shoe main body object 52 is in contact with the field object 42, the α value of the second portion 54b of the turf object 54 is set to the basic value, and the α value of the other portion is set to the predetermined value (for example, value corresponding to the complete transparency) indicating a transparency higher than the basic value.

In the α value controlling information (first α value controlling information) for the case where the shoe main body object 52 is not in contact with the field object 42, the α values of all of the points of the turf object 54 are set to the predetermined value (for example, value corresponding to the complete transparency) indicating a transparency higher than the basic value.

The game device 10 according to the third embodiment also executes processing similar to the processing (see FIG. 8) which is executed by the game device 10 according to the first embodiment. However, the processing according to the third embodiment is different from the processing according to the first embodiment in such points as described below.

In the processing of Step S101, the position of each vertex of the turf object 54 is also updated. For example, the position of each vertex of the turf object 54 is updated based on the position of the shoe main body object 52. Note that in the third embodiment, data that defines a change of the position of each vertex of the turf object 54 in each frame in the case where the player object 46 performs various actions (for example, running action) may be stored. In other words, data that defines a change of the position of each vertex of the turf object 54 in each frame in the case where the various kinds of the motion data (for example, running motion data) are reproduced may be stored. The above-mentioned data and the motion data may be provided as integral data. In this case, in the processing of Step S101, the position of each vertex of the turf object 54 in the current frame is specified from the above-mentioned data, and the position of each vertex of the turf object 54 is set to that position.

In addition, in the processing of Step S103, the α value of each point of the turf object 54 is set based on the first α value controlling information. In this case, the α values of all of the points of the turf object 54 are set to the value corresponding to complete transparency. As a result, if the shoe main body object 52 is not in contact with the field object 42, the turf object 54 is not displayed on the game screen. That is, the limitation is imposed on the display-output of the turf object 54 on the game screen.

In addition, in the processing of Step S105, the α value of each point of the turf object 54 is set based on the second α value controlling information. In this case, the α value of all of the points of the turf object 54 are set to the value corresponding to the complete opacity. As a result, the entirety of the turf object 54 is displayed on the game screen, and the state in which the shoe of the soccer player is hidden by the turf is displayed on the game screen. Note that when a texture image is mapped to the turf object 54, with regard to a point of the points of the turf object 54 which is associated with a region in which the turf is not drawn within the texture image, the α value is set to the value corresponding to the complete transparency.

In addition, in the processing of Step S107, the α value of each point of the turf object 54 is set based on the third α value controlling information. In this case, the α value of the first portion 54a of the turf object 54 is set to the value corresponding to complete opacity, and the α value of the other portion is set to the value corresponding to complete transparency. As a result, the first portion 54a (portion corresponding to the toe-side portion 52a) of the turf object 54 is displayed on the game screen, and the display-output of the other portion is restricted. As a result, the state in which only the toe portion of the shoe of the soccer player is hidden by the turf is displayed on the game screen.

In addition, in the processing of Step S108, the α value of each point of the turf object 54 is set based on the fourth α value controlling information. In this case, the α value of the second portion 54b of the turf object 54 is set to the value corresponding to complete opacity, and the α value of the other portion is set to the value corresponding to complete transparency. As a result, the second portion 54b of the turf object 54 (portion corresponding to the heel-side portion 52b) is displayed on the game screen, and the display-output of the other portion is restricted. As a result, the state in which only the heel portion of the shoe of the soccer player is hidden by the turf is displayed on the game screen.

Incidentally, the turf object control data according to the third embodiment may be set as data that defines a transparency of each point of the turf object 54 in each frame in the case where the player object 46 performs various actions (for example, running action). In other words, the turf object control data may be set as data that defines a change of the transparency of each point of the turf object 54 in each frame in the case where the various kinds of motion data (for example, running motion data) are reproduced.

In this case, for example, in the frame in which the player object 46 is raising its right foot (that is, frame in which the right foot of the player object 46 is not in contact with the ground), the α values of all of the points of the turf object 54 associated with the shoe main body object 52 corresponding to the right foot are set to the predetermined value (for example, value corresponding to complete transparency) indicating a transparency higher than the basic value (for example, value corresponding to complete opacity).

Further, for example, in the frame in which the toe and the heel of the right foot of the player object 46 are in contact with the ground, the α values of all of the points of the turf object 54 associated with the shoe main body object 52 corresponding to the right foot are set to the basic value (for example, value corresponding to complete opacity).

Further, for example, in the frame in which the toe of the right foot of the player object 46 is in contact with the ground with the heel thereof not being in contact with the ground, the α value of the first portion 54a of the turf object 54 associated with the shoe main body object 52 corresponding to the right foot is set to the basic value (for example, value corresponding to complete opacity), and the α value of the other portion is set to the predetermined value (for example, value corresponding to complete transparency) indicating a transparency higher than the basic value.

Further, for example, in the frame in which the heel of the right foot of the player object 46 is in contact with the ground with the toe thereof not being in contact with the ground, the α value of the second portion 54b of the turf object 54 associated with the shoe main body object 52 corresponding to the right foot is set to the basic value (for example, value corresponding to complete opacity), and the α value of the other portion is set to the predetermined value (for example, value corresponding to complete transparency) indicating a transparency higher than the basic value.

The turf object control data as described above is, for example, prepared for each motion data item and stored in association with each motion data item. Alternatively, the motion data and the turf object control data may be provided as integral data.

Further, the turf object control data as described above is reproduced in synchronization with the reproduction of the motion data. That is, the transparency of each point of the turf object 54 is changed according to the turf object control data in synchronization with the state of the foot skeleton of the player object 46 (in other words, position of each vertex of the shoe main body object 52 or posture of the shoe main body object 52) being changed according to the motion data. For example, in the processing illustrated in FIG. 8, such processing as described below is executed in place of the processing of Steps S102 to S108. That is, the transparency of each point of the turf object 54 in the current frame is specified from the turf object control data, and the transparency of each point of the turf object 54 is set. Note that even in such a case, it may be confirmed whether or not the shoe main body object 52 is in contact with the field object 42, and the limitation may be imposed on the display-output of the entirety or a part of the turf object 54 based on the result of the confirmation. This can prevent, for example, the turf object 54 from being displayed in a state in which the shoe main body object 52 is not in contact with the field object 42.

In the same manner as the game device 10 according to the first embodiment, also with the game device 10 according to the third embodiment, it becomes possible to alleviate the processing load in the case of expressing the state in which a part of the foot (shoe) of the soccer player is hidden by the turf growing on the field. Further, also with the game device 10 according to the third embodiment, it becomes possible to ensure that the user is not made to feel uneasy due to the turf being displayed in the vicinity of the foot (shoe) regardless of the distance between the foot (shoe) of the soccer player and the field being large. Further, also with the game device 10 according to the third embodiment, it becomes possible to ensure that the user is not made to feel uneasy due to the turf being displayed in the vicinity of a portion of the foot (shoe) of the soccer player which is not in contact with the field.

Note that the present invention is not limited to the embodiments described above.

For example, the turf object 54 may be set as such an object as to surround the shoe main body object 52. In addition, the shoe object 50 may include a plurality of turf objects 54. In that case, those plurality of turf objects 54 may be located so as to surround the shoe main body object 52.

Further, for example, the present invention can also be applied to a case other than the case where the state in which a part of the shoe (foot) of the soccer player is hidden by the turf growing on the field is expressed. For example, in the same manner as the shoe main body object 52 (shoe object 50), by associating the turf object 54 with the ball object 48 (second object) as well, it becomes possible to express a state in which a part of the soccer ball is hidden by the turf growing on the field.

Further, the present invention can also be applied to a game other than the soccer game. For example, the present invention can also be applied to an action game, a role-playing game, and the like in which a character object moves in a virtual three-dimensional space. For example, in a case where an object (first object) representing grassland or a sandy place is located in the virtual three-dimensional space, an object (third object) representing grass or sand may be associated with a foot object (second object) of the character object in the same manner as the turf object 54. Accordingly, it becomes possible to express a state in which the foot is hidden by the grass or the sand in a case where a game character sets foot into the grassland or the sandy place while achieving the alleviation of the processing load. Further, for example, in a case where an object (first object) representing a marshy place or a puddle is located in the virtual three-dimensional space, an object (third object) representing mud or water may be associated with the foot object (second object) of the character object in the same manner as the turf object 54. Accordingly, it becomes possible to express a state in which the foot is hidden by the mud or the puddle in a case where the game character sets foot into the marshy place or the puddle while achieving the alleviation of the processing load. Note that, for example, in the case where the object (first object) representing a grassland or a sandy place is located in the virtual three-dimensional space, the object (third object) associated with the foot object (second object) of the character object is not limited to the object representing grass or sand. An object (third object) other than the object representing grass or sand may be associated with the foot object (second object) of the character object.

Note that every one of the examples that have been described so far is an example in which the limitation is imposed on the display-output of the third object in a case where the first object (for example, field object 42) has come away from the second object (for example, shoe main body object 52) and the third object (for example, turf object 54), and in which the limitation of the display-output of the third object is removed in a case where the first object has come close to the second object and the third object. However, the limitation may be imposed on the display-output of the third object in the case where the first object has come close to the second object and the third object, while the limitation of the display-output of the third object may be removed in the case where the first object has come away from the second object and the third object. For example, the limitation may be imposed on the display-output of a mud object (third object) in a case where a shoe main body object (second object) has come close to a puddle object (first object) provided on the field, while the limitation of the display-output of the mud object may be removed in a case where the shoe main body object comes away from the puddle object. Accordingly, it becomes possible to express a state in which mud sticks to the shoe if the game character sets foot out of the puddle, and in which the mud that has stuck to the shoe disappears if the game character sets foot in the puddle. Further, every one of the examples that have been described so far is an example in which the second object (for example, shoe main body object 52) moves so as to cause the distance from the first object (for example, field object 42) to change. However, for example, the second object may be such an object as to move while being in contact with the first object. In such an aspect, in a case where there is a change in posture of the second object, the limitation may be imposed on the display-output of the entirety or a part of the third object for performing the display-output regarding the first object based on what kind of posture is taken by the second object while the second object is in contact with the first object.

Further, for example, in the above-mentioned description, the program is provided to the game device 10 via the optical disk 36 serving as an information storage medium, but the program may be delivered to the game device 10 via a communication network. FIG. 12 is a diagram illustrating an overall configuration of a program delivery system using the communication network. With reference to FIG. 12, description is given of a program delivery method according to the present invention. As illustrated in FIG. 12, a program delivery system 100 includes the game device 10, a communication network 106, and a program delivery device 108. The communication network 106 includes, for example, the Internet and a cable television network. The program delivery device 108 includes a database 102 and a server 104. In the system, the same program as the program stored on the optical disk 36 is stored in the database (information storage medium) 102. Then, a demander uses the game device 10 to make a game delivery request, whereby the game delivery request is transferred to the server 104 via the communication network 106. Then, the server 104 reads out the program from the database 102 according to the game delivery request, and transmits the program to the game device 10. Here, the game delivery is performed in response to the game delivery request, but the server 104 may transmit the program one-sidedly. In addition, all of programs necessary to implement the game are not necessarily delivered at one time (delivered collectively), and necessary parts may be delivered (split and delivered) depending on which phase the game is in. By thus performing the game delivery via the communication network 106, the demander can obtain the program with ease.

1. An image processing device for displaying on a screen a virtual three-dimensional space in which a first object and a second object are located, comprising:
means for locating a third object for performing display-output related to the first object in the virtual three-dimensional space, and causing the third object to move according to movement of the second object; and
restricting means for restricting the display-output of the third object on the screen based on a distance between the first object, and the second object or the third object.

2. An image processing device for displaying on a screen a virtual three-dimensional space in which a first object and a second object are located, comprising:
means for locating a third object for performing display-output related to the first object in the virtual three-dimensional space, and causing the third object to move according to movement of the second object; and
restricting means for restricting the display-output of the third object on the screen according to a change of a distance between the first object, and the second object or the third object.

3. An image processing device according to claim 1 or 2, wherein:
the second object is a three-dimensional object; and
the restricting means restricts the display-output of the third object on the screen by including the entirety or a part of the third object in the second object.

4. An image processing device according to claim 1 or 2, wherein the restricting means restricts the display-output of the third object on the screen by reducing a size of the third object.

5. An image processing device according to claim 1 or 2, further comprising means for storing third object control data obtained by associating a condition regarding the distance between the first object, and the second object or the third object, with position controlling information regarding position control of a vertex of the third object,
wherein the restricting means controls the position of the vertex of the third object based on the position controlling information corresponding to the condition satisfied by a current distance between the first object, and the second object or the third object.

6. An image processing device according to claim 1 or 2, further comprising means for storing third object control data for specifying a position of a vertex of the third object in each frame in a case where the second object moves,
wherein the restricting means controls the position of the vertex of the third object based on the third object control data.

7. An image processing device according to claim 1 or 2, wherein the restricting means restricts the display-output of the third object on the screen by increasing a transparency of the entirety or a part of the third object.

8. An image processing device according to claim 7, further comprising means for storing third object control data obtained by associating a condition regarding the distance between the first object, and the second object or the third object, with transparency controlling information regarding transparency control of each point of the third object,
wherein the restricting means controls the transparency of each point of the third object based on the transparency controlling information corresponding to the condition satisfied by a current distance between the first object, and the second object or the third object.

9. An image processing device according to claim 7, further comprising means for storing third object control data for specifying the transparency of each point of the third object in each frame in a case where the second object moves,
wherein the restricting means controls the transparency of each point of the third object based on the third object control data.

10. An image processing device according to claim 1 or 2, wherein the restricting means restricts the display-output of the third object on the screen in a case where the distance between the first object, and the second object or the third object, is larger than a predetermined distance.

11. An image processing device according to claim 10, wherein the restricting means comprises means for restricting the display-output of a part of the third object on the screen based on a posture of the second object in a case where the distance between the first object, and the second object or the third object, is equal to or smaller than the predetermined distance.

12. A control method for an image processing device for displaying on a screen a virtual three-dimensional space in which a first object and a second object are located, comprising:
a step of locating a third object for performing display-output related to the first object in the virtual three-dimensional space, and causing the third object to move according to movement of the second object; and
a restricting step of restricting the display-output of the third object on the screen based on a distance between the first object, and the second object or the third object.

13. A control method for an image processing device for displaying on a screen a virtual three-dimensional space in which a first object and a second object are located, comprising:
a step of locating a third object for performing display-output related to the first object in the virtual three-dimensional space, and causing the third object to move according to movement of the second object; and
a restricting step of the display-output of an entirety or a part of the third object on the screen according to a change of a distance between the first object, and the second object or the third object.

14. A program for causing a computer to function as an image processing device for displaying on a screen a virtual three-dimensional space in which a first object and a second object are located,
the program further causing the computer to function as:
means for locating a third object for performing display-output related to the first object in the virtual three-dimensional space, and causing the third object to move according to movement of the second object; and
restricting means for restricting the display-output of the third object on the screen based on a distance between the first object, and the second object or the third object.

15. A program for causing a computer to function as an image processing device for displaying on a screen a virtual three-dimensional space in which a first object and a second object are located,
the program further causing the computer to function as:
means for locating a third object for performing display-output related to the first object in the virtual three-dimensional space, and causing the third object to move according to movement of the second object; and
restricting means for restricting the display-output of an entirety or a part of the third object on the screen according to a change of a distance between the first object, and the second object or the third object.

16. A computer-readable information storage medium recorded with a program for causing a computer to function as an image processing device for displaying on a screen a virtual three-dimensional space in which a first object and a second object are located,
the program further causing the computer to function as:
means for locating a third object for performing display-output related to the first object in the virtual three-dimensional space, and causing the third object to move according to movement of the second object; and
restricting means for restricting the display-output of the third object on the screen based on a distance between the first object, and the second object or the third object.

17. A computer-readable information storage medium recorded with a program for causing a computer to function as an image processing device for displaying on a screen a virtual three-dimensional space in which a first object and a second object are located,
the program further causing the computer to function as:
means for locating a third object for performing display-output related to the first object in the virtual three-dimensional space, and causing the third object to move according to movement of the second object; and
restricting means for restricting the display-output of an entirety or a part of the third object on the screen according to a change of a distance between the first object, and the second object or the third object.
